(19) United States
(12) Patent Application Publication
(10) Pub. No.: US 2010/0072295 A1
(43) Pub. Date: Mar. 25, 2010

(54) APPARATUS AND METHOD FOR SPREADING PARTICULATE MATERIAL

(75) Inventors: Edward Raymond Usmar, Waikato (NZ); Samuel Thomas Lynch, Matamata (NZ); Bertram Francis Charles Quin, Auckland (NZ)

Correspondence Address: YOUNG & THOMPSON, 209 Madison Street, Suite 500, Alexandria, VA, 22314, US

(73) Assignee: QUINSPREAD TECHNOLOGIES LIMITED, Auckland (NZ)

(21) Appl. No.: 12/598,556

(22) PCT Filed: May 1, 2008
(86) PCT No.: PCT/NZ2008/000097

§ 371 Date: Nov. 2, 2009

(30) Foreign Application Priority Data
May 2, 2007 (NZ) 554915

(51) Int. Cl. A01C 17/00; A01C 15/04; E01C 19/21

(52) U.S. Cl. 239/1; 239/304; 239/310; 239/681; 239/172

(57) ABSTRACT

A truck mounted particulate material ground spreading apparatus mixes substantially dry particulate material with from 7-20% of water w/w immediately before supplying the wetted particles to a spreader disc to spread the wetted particles onto the ground. The apparatus (4) has a plurality of grinding discs (12a, 12b, 12c) above a mixing chamber (7) so that particulate material can be dry ground before mixing with water in the mixing chamber (7) and delivery to the spreader disc (19). The grinding discs (12a, 12b, 12c) and spreader disc (19) are mounted on a common shaft (14) driven by a hydraulic motor.

### FIELD OF THE INVENTION

This invention relates to apparatus and a method for spreading particulate material, and in particular, but not exclusively to apparatus and a method for use in the foliar application of urea to farm pastures.

### BACKGROUND

There are a number of applications where it is necessary to spread particulate material over an area. A prime example is the spreading of fertilizers to pastures or other crops. However, there are other applications, for example the spreading of salt on icy roads or the application of chemicals or inhibitors to restore a polluted environment.

Fertiliser is generally applied in either
a) a solid form, e.g. granules, crystals or powder, principally for ease of handling and application and to assist in controlling the rate of release, and/or
b) as a liquid, for rapid uptake and/or to assist in providing even distribution.

The rate of solid fertilizer release may be controlled by the choice of fertilizer type, varying the size of the particles/granules and or coating with polymers or release inhibitors. In the case of liquid fertilizers, rate of release may be controlled by the choice of fertilizer and/or by the amount of liquid co-applied.

There are however a number of known problems in applying solid fertilizer, including:
risk of pollution to waterways from run-off if solid fertilizer application is followed by rain or irrigation,
fertilizer dust during transportation and particularly during spreading can also lead to environmental pollution, or significant loss of the fertilizer as it may be blown away before it settles on its intended location,
Wind blown fertilizer dust can also pose a health risk to humans and animals, or even to surrounding plants or other vegetation that are not suited to the particular fertilizer, and
urea fertilizer may in some conditions undergo excessively rapid hydrolysis, leading to substantial losses of ammonia gas to the atmosphere. This volatilization of ammonia may be inhibited by coating the fertilizer with a urease inhibitor before application.

Furthermore, products such as lime and direct-application soft phosphate rock (called reactive phosphate rock or RPR in New Zealand and Australia), need to be applied in a finely ground form to be agronomically effective. Lime is usually crushed into fine particles in the quarry where it is mined, while RPR is usually crushed prior to beneficiation to improve the grade, at or near the mining site. Both may require limited additional grinding/crushing prior to application. These crushed products can be extremely dusty, creating dust drift and associated problems.

Lack of uniformity of particle size is also a problem. Most solid form fertilizer is distributed by means of spinning spreader disks, and the width of spread is related to particle size.

An alternative to applying fertilizers in particulate form is to apply them as liquids. Urea or urea ammonium nitrate (UAN) is sometimes applied in this way. However, there are also a number of disadvantages of applying fertilizers as liquids, whether in suspension or in solution. These disadvantages include;
(i) the cost of transportation of the typically required 40-60% weight content of water,
(ii) the requirement for either; (a) centrally located grinding equipment for grinding of solid fertilizer into the required particle-size range, and the associated mixing and storage equipment, or (b) a mobile equivalent of the same, both of which require manpower to operate.
(iii) the necessity to use high quality and therefore high cost ingredients, and in addition in the case of suspensions, the incorporation of additives such as bentonite clay to keep products in suspension, and
(iv) the pumps, pipe-work and nozzles used to distribute liquid fertilizers can be prone to blockages or undue corrosion due to the corrosive nature of many fertilizers.

Fertiliser is relatively heavy and is generally applied in large volumes using trucks. Tractor mounted or towed equipment is also used but generally on a smaller scale. In situations however where it is not possible to drive a vehicle on the land, for example very hilly land, or over sensitive crops, fertilizer can be applied by aircraft. Weight is generally an important factor however, and the trucks and aircraft that are used need to be relatively robust and powerful, and the trucks generally require larger tyres to reduce ground pressure. The costs associated with spreading fertilizer often means that the fertilizer is spread dry rather than in solution or in suspension, due to the significant weight of water used to create the solutions or suspensions.

### OBJECT

It is therefore an object of the present invention to provide apparatus or a method for the spreading of particulate material which will at least go some way towards overcoming the above mentioned problems, or at least provide the public with a useful choice.

### STATEMENTS OF INVENTION

Accordingly, in a first aspect, the invention may broadly be said to consist in a particulate material spreading apparatus having a mixing chamber, the mixing chamber having a particulate material inlet and a liquid inlet, the apparatus also including agitation means adapted to mix any substantially dry particulate material that enters the chamber with any liquid that is introduced into the chamber, and the apparatus further including delivery means adapted to expel any combined particulate material and liquid from the chamber in such a manner that the combined particulate material and liquid can be spread over a surface in the vicinity of the apparatus.

Preferably the apparatus is adapted for operation while being transported by a vehicle.

Preferably the vehicle is adapted to carry particulate material and liquid in a manner that allows the particulate material and the liquid to be supplied to the apparatus while the vehicle is moving.

Preferably the apparatus further includes grinding or crushing means adapted to reduce the particle size of the particulate material.

Preferably the apparatus is configured to receive particulate material into an upper part of the apparatus and to expel any combined particulate material and liquid from a lower part of the apparatus.

Preferably the chamber is provided with an outlet slot through which combined particulate material and liquid can be expelled from the apparatus.

Preferably the grinding or crushing means includes one or more rotatable members adapted to grind or crush particulate material against a cylindrical surface.

Preferably the apparatus further includes air acceleration means adapted to produce airflow to assist in the movement of particulate material through the apparatus.

Preferably one or more blades on the rotatable members of the grinding or crushing means form at least a part of the air acceleration means.

Preferably the blades are configured such that their extremities pass adjacent to the cylindrical surface when they rotate.

Preferably the extremities of the blades are configured to crush or grinding particulate material against the cylindrical surface.

Preferably the agitation means and the delivery means are situated within the chamber.

Preferably the grinding or crushing means is also situated within the chamber.

Preferably the grinding or crushing means is adapted to grind or crush particulate material that is in the form of granules into particulate material in which at least sixty percent of the material has a particle size that is less than 0.5 millimetres across.

Preferably the chamber has a generally cylindrical shape.

Preferably at least a part of an inner surface of the chamber is made from a wear resistant material.

Preferably the agitation means includes rotating vanes.

Preferably the delivery means includes a rotatable slinging device.

Preferably the agitation means is adapted to deliver any combined particulate material and liquid toward a centre of the rotatable slinging device.

Preferably the apparatus is configured to mix particulate material and liquid to form a wetted particulate material or a paste having a liquid content in the range of five to forty percent by mass.

More preferably the apparatus is configured to mix particulate material and liquid to form a wetted particulate material or a paste having a liquid content in the range of seven to twenty percent by mass.

In a second aspect, the invention may broadly be said to consist in a vehicle or aircraft incorporating at least one particulate material spreading apparatus substantially as specified herein.

Preferably the vehicle also includes storage and supply means adapted to store and to supply both particulate material and a liquid to the or each particulate material spreading apparatus.

Preferably the vehicle also includes control means adapted to control the rate at which particulate material and/or liquid enters the or each particulate material spreading apparatus.

In a third aspect, the invention may broadly be said to consist in a method of spreading particulate material from a moving vehicle, the method including the steps of;
mixing the particulate material with a liquid to form a mixture having a slurry or paste-like consistency while the particulate material and the liquid are being carried by the vehicle,
keeping the mixture in discrete globules or breaking the mixture into discrete globules,
slinging the globules over a surface as the vehicle moves over it.

Preferably the method further includes a step of grinding or crushing the particulate material to reduce or standardise the particle size while the particulate material is being carried by the vehicle.

Preferably the liquid includes water.

Preferably the method is a method of spreading fertilizer.

Optionally the method further includes the addition of a chemical or compound to the liquid, for example a chemical or compound adapted to condition the particulate material.

Optionally the chemical or compound is a nitrification and/or urease inhibitor.

In a further aspect of the present invention there is provided a vehicle which is adapted to:
convert a solid or a particulate material into a wetted particulate material or paste, and
dispense the wetted particulate material or paste to a surface;
   the vehicle including:
a particulate material supply and an associated particulate material transfer means, and
a liquid supply and an associated liquid transfer means,
   characterised in that the vehicle includes a particulate material spreading apparatus or converter apparatus for converting the particulate material to a wetted particulate material or paste, the converter apparatus including:
a crushing assembly for crushing the particulate material, the crushing assembly having a material inlet adapted to receive particulate material from the particulate material transfer means, and
a mixing assembly adapted to receive:
   a liquid from the liquid supply, and
   crushed, material from the crushing assembly,
the mixing assembly capable of mixing the liquid from the liquid supply with the crushed material to produce a wetted particulate product or a paste;
   the vehicle further including a dispensing means for dispensing the wetted particulate product or a paste from the mixing assembly onto the surface.

In another aspect of the present invention there is provided a vehicle which is adapted to:
convert a particulate material to a wetted particulate material, and
dispense a wetted particulate material to a surface;
   the vehicle including:
a particulate material supply and an associated particulate material transfer means, and
a liquid supply and an associated liquid transfer means,
   characterised in that the vehicle includes a converter apparatus for converting the particulate material to a wetted particulate material, the converter apparatus including:
a crushing assembly for crushing the particulate material, the crushing assembly having a material inlet adapted to receive particulate material from the particulate material transfer means, and
a mixing and treating assembly adapted to receive:
   liquid from the liquid supply, and
   crushed material from the crushing assembly of a predetermined size range,
the mixing assembly capable of mixing the liquid from the liquid supply with the crushed material to produce a combined wetted product;
   the vehicle further including a dispensing assembly for dispensing the combined wetted product from the mixing assembly onto the surface.

In one embodiment, one or more liquid supplies may be provided for supplying additive substances such as inhibitors and/or trace elements to the mixing assembly.

According to another aspect of the present invention there is provided a converter apparatus for converting a particulate material to a wetted particulate material, said converter apparatus including:
a grinding or crushing means for reducing the particle size of the particulate material, and
a mixing assembly adapted to receive the crushed product from the crushing assembly and mix with liquid from the liquid supply to produce a wetted particulate material.

A converter apparatus, substantially as hereinbefore described, said apparatus further including a dispensing assembly for dispensing the wetted particulate material or product from the mixing assembly.

For ease of reference only, and unless context dictates otherwise, the present invention will now generally be described in relation to an application where the particulate material is a fertilizer to be mixed with a liquid such as water and/or an additive.

The most commonly used liquid will be water however other liquids may also be used, for example, inhibitors, inhibitor coatings, liquid fertilizers, minerals or trace elements or the like.

As aforementioned and used herein the term “particulate material” refers to any solid material which it is desired to break into smaller particles before mixing with a liquid. In general the term “particulate material” may include chunks, lumps, chips, grains, crystals, pellets and/or granules of material whose size may need to be reduced.

In preferred embodiments the particulate material may be a fertilizer and more preferably is a urea-based fertilizer. However, this should not be seen to be limiting as the present invention may be suitable for other fertilizers or particulate material.

The particulate material is preferably crushed by the crushing assembly to generally reduce in size the majority of the constituent parts of the particulate material. It will be appreciated that reference to “crush” in the forgoing description and as used herein should be understood to include any one or more of the following: collisions; breaking; pounding; compression; of the particulate material to break into smaller fragments, or particles, and includes the propulsion of the particulate material onto another object.

The vehicle may be almost any vehicle capable of being adapted to deliver fertilizer. However, in general the vehicle may be a land vehicle.

Preferably, the vehicle of the present invention may be self-propelled.

Although it will be appreciated that the vehicle may also include non-powered vehicles such as trailers, carriages or other mobile supports.

It will be appreciated that the vehicle may include one or more power sources and or drive mechanisms to propel the vehicle and to drive the:
particulate material transfer means;
liquid transfer means;
crushing assembly;
mixing assembly;
dispensing assembly; or
a combination of the above.

In one preferred embodiment the spreader includes an engine for self-propulsion. Preferably said engine is configured to power the converter apparatus, particulate material transfer means, and/or liquid transfer means via one or more hydraulic drives.

It will be appreciated that one or more other known drive mechanisms may be suitably configured to drive the converter apparatus, particulate material/liquid transfer means, mixing assembly and/or dispensing assembly. For example, Power Take Off (PTO) units, electric engines, pneumatic drives, mechanical drive systems or the like.

Preferably, the particulate material and liquid may be stored separately on the vehicle in respective vehicle containers, tanks, hoppers or the like, though it will be appreciated that other storage devices may also be utilised. The particulate material may be a single product (e.g. urea) or a mix of two or more products.

In some embodiments the particulate material and/or liquid supply may be provided in containers or the like external to the vehicle and connected to the vehicle via one or more conduits. For example, the liquid supply may be a water tank on another vehicle connected via a flexible hose extending to the vehicle and converter apparatus or alternatively from a stationary water tank connected via the flexible hose.

In one preferred embodiment a further liquid supply is provided in the form of an additive supply to be mixed with the particulate and/or crushed material. The additive may be any known product such as polymer coatings, inhibitors, acids or other reactive materials, trace elements, minerals or additional fertilizer types, oils, or any other product which is desired to be mixed with the particulate and/or crushed material.

Preferably the additive supply is provided in a container, tank or the like separate to the liquid supply to inhibit any premature mixing. The additive supply may also be operatively associated with an additive transfer means similar to the liquid transfer means.

Preferably, the particulate material and liquid transfer means may be powered devices to thus provide means for controlling the flow rate of particulate material and liquid to the converter apparatus. For example, the particulate material transfer means may include an adjustable speed conveyer-belt or the like and the liquid transfer means may include a pump and/or valve arrangement in a pipe connecting the liquid supply to the converter apparatus.

In alternative embodiments the particulate material and liquid transfer means may not be active devices and may include conduits or apertures coupled to corresponding inlets of the crushing and mixing assemblies, the particulate material and liquid being transferred under gravity.

The crushing assembly is preferably adapted to produce substantially crushed material e.g. powder, crystals and small granules, or fragments and the like generally comprising smaller constituent particles than that of the particulate material.

It will be appreciated by one skilled in the art that numerous crushing assembly types may be utilised in the present invention, such as jaw, gyratory, cone, grinder, mincer, or impact crushers. However, in preferred embodiments the crushing assembly is a grinder-type crusher adapted to crush the particulate material between two surfaces, at least one of the surfaces movable relative to the other.

In one preferred embodiment, the crushing assembly may include one or more movable crushing members in an enclosure with a material inlet therein, the crushing assembly configured to crush the particulate material between the crushing member(s) and an inner wall (crushing wall) of the enclosure and/or via collision of the material against the crushing wall.

Preferably, the, or each, crushing member may be substantially disc-shaped and rotatable within the enclosure, the enclosure having a substantially cylindrical crushing wall.

Preferably the crushing wall of the enclosure has one or more protrusions to provide improved crushing i.e. by providing more crushing points than a comparative smooth wall.

Preferably the rotatable disc includes at least one opening for permitting passage of crushed material therethrough. This opening thus allows for crushed material to pass to the mixing assembly. In a further embodiment the crushing assembly is configured such that the majority of crushed material may pass to the mixing assembly from between the crushing disc and crushing wall.

It will be appreciated that numerous mixing assemblies may be utilised in the present invention and may include active mixing blades, discs, ball-bearings, jets of liquid, spray nozzles, screw-drives, vortex chambers, liquid baths, and the like or any device capable of mixing a crushed material with a liquid.

Preferably, the mixing assembly is adapted to receive crushed material from the crushing assembly through an aperture or other opening. Preferably, the crushed material falls through the aperture under gravity though it will be appreciated that active transport mechanisms may be utilised such as conveyors or, the like.

In an alternative embodiment, the mixing assembly may be adapted to receive crushed material from the crushing assembly via a passage, conduit, or the like, communicatively coupled to the crushing assembly.

Preferably, the mixing assembly is adapted to receive liquid from the liquid supply via at least one liquid inlet. The liquid may be supplied to the inlet by one or more conduits with associated pumps or alternatively the liquid may be supplied under gravity.

In one preferred embodiment, the mixing assembly includes at least one movable mixing member in an enclosure with a liquid inlet therein and a wetted particulate material outlet.

Preferably, the mixing member includes one or more blades or the like, rotatable within the enclosure, the enclosure having a substantially cylindrical inner wall (mixing wall).

Preferably the liquid inlet is provided as a passage through the enclosure for passing liquid from the liquid supply. It will be appreciated that multiple liquid inlets may be provided, each connected to one or more liquid supplies.

It will be appreciated that the dispensing assembly may take any form of liquid product dispensers. For example, the dispensing assembly may include pumps, pipe, spray and/or nozzle systems, irrigation systems, spinning discs, propellers, blowers, booms and the like.

In preferred embodiments the dispensing assembly includes at least one rotatable impeller adapted to receive the wetted particulate material from the converter apparatus and to impel the product onto a surface.

The force imparted to the combined liquid product, and therefore the distance it may travel, may thus be varied by changing the speed of rotation, of the impeller or by increasing the number of impellers from one, to two or more.

While it will be understood by one skilled in the art that the crushing and mixing assemblies may be provided as separate devices connected to each other, in preferred embodiments, the crushing and mixing assemblies are formed as a combined device, the mixing and crushing members provided in a single enclosure.

Preferably the dispensing assembly is also located within the enclosure with the mixing and crushing members, the enclosure including a wetted particulate material outlet and the dispensing assembly adapted to receive the wetted particulate material from the mixing assembly and eject the wetted particulate material out of the combined liquid product outlet.

In general, the particulate material is likely to be most easily crushed in a substantially dry state as a wetted particulate material may stick to the crushing wall between the protrusions and create a ‘smooth’ surface. Thus, in a preferred embodiment, the crushing member is located proximate the particulate material inlet of the enclosure, and the mixing member located distal to said particulate material inlet, the crushing and mixing members configured such that the particulate material must first pass through the crushing assembly before passing to the mixing assembly. However, it will be appreciated that a combined crushing and mixing assembly that is capable of both crushing the particulate material and mixing the crushed product with liquid in a single process is also considered within the scope of the present invention.

Preferably, the crushing and mixing assemblies are configured in use to rotate about substantially vertical axes within the enclosure. Thus, particulate material may fall under gravity from the particulate material inlet to the crushing assembly to be crushed, or bypass the crushing assembly thus enabling the solid product to be wetted in its original form and then to the mixing assembly to be mixed with the liquid. Preferably, the crushing and mixing assembly rotation axes are substantially coaxial.

Preferably, the, or each dispensing impeller, crushing and mixing members are all connected to a common axle or the like to rotate simultaneously. It will also be appreciated that in alternative embodiments the, or each dispensing impeller, crushing and mixing members may be configured to rotate independently. Moreover, it will be appreciated that one skilled in the art may be capable of adapting the converter apparatus and dispensing assembly such that at least one of the impeller, crushing member and mixing member are contra-rotating with respect to the others.

Preferably, the crushing and mixing assemblies are configured to inhibit the passage of liquid from the mixing assembly to the crushing assembly. Inhibiting liquid entry into the crushing assembly may thus assist in ensuring effective crushing may continue, as the particulate material may become more difficult to crush if mixed with the liquid.

For example, in one preferred embodiment, the cylindrical crushing wall may have a smaller diameter than the cylindrical mixing wall, providing a step therebetween, a separation plate may also be provided between the crushing and mixing members, the plate having a larger diameter than the crushing wall. Thus, when in use, the majority of liquid in the mixing assembly will be forced against the mixing wall through centrifugal effects of the rotating mixing member(s) and any liquid passing toward the crushing member is stopped either by the separation plate, or by the step between the mixing and crushing walls.

In an alternative embodiment, a shutter or valve assembly may be provided between the crushing and mixing assemblies to permit passage of particulate material to the mixing assembly and/or inhibit return of liquid to the crushing assembly.

The converter apparatus, substantially as aforementioned and further characterised by the inclusion of a control system for controlling the respective flow-rate of the particulate material liquid and/or additive from the particulate material, liquid and additive supplies via the particulate material and liquid transfer means, to the crushing and mixing assemblies.

Preferably, the control system includes a microprocessor or computer system suitably programmed to control:
the respective rate of crushing and/or mixing by the crushing and mixing assemblies,
the respective rate of dispensing by the dispensing assembly, and/or
the speed of the vehicle.

The control system may thus allow an operator or computer system to monitor the vehicle and converter apparatus and set the amount of particulate material and liquid being mixed together to provide a defined liquid level of the wetted particulate material. The control system may also allow the quantity, spread and concentration of the combined liquid product applied to a surface to be monitored and precisely controlled.

Furthermore, the control system may ensure optimum spreading performance by dictating the speed at which the vehicle operates in regard to the change in the contour of the surface to which the wetted particulate material is being applied.

In some applications it may be necessary to apply a partially crushed material, and/or a material without being combined with a liquid, to the surface. Thus in one embodiment, the control system may be adapted to control the rate of crushing by the crushing assembly to permit passage of the particulate material to pass to the mixing and/or dispensing assemblies without undergoing substantial crushing. This may be achieved for example by reducing the rate of crushing to such an extent that the crushing assembly performs only minimal, if any, crushing to the particulate material. In another embodiment the control system may be adapted to prevent the supply of liquid to the mixing assembly thereby preventing mixing of the solid and/or crushed material and allowing a non-wetted particulate material to be applied to the surface.

The control system preferably comprises one or more microprocessors or computer systems, sensors and/or actuators linked to the vehicle and converter apparatus to control same.

Preferably at least one sensor is linked to the control system and capable of measuring one or more factors of operation. By way of example, the factors of operation may include:
vehicle speed;
rate of crushing and/or mixing;
rate of dispensing;
temperature of one or more components of the spreader and/or converter apparatus;
volume flow rate of liquid and/or particulate material to the converter apparatus;
pressure of the liquid in the liquid supply, transfer means and/or converter apparatus;
concentration of additives e.g. of trace elements or inhibitors;
hydraulic drive pressure and/or flow-rate;
any other factor of spreader and/or converter apparatus operation.

Preferably, the control system is adapted to receive signals from the, or each, sensor indicative of a factor of operation and configured to change said factor to within predetermined limits if the, or each, sensor indicates the factor is outside said predetermined limits.

According to another aspect of the present invention there is provided a wetted particulate material produced by the converter apparatus, substantially as aforementioned, the wetted particulate material including at least one component of crushed material and at least one component of liquid.

Preferably said crushed material is a crushed fertilizer and said liquid is water, though this should not be seen to be limiting as the liquid may also be a coating of polymers, release inhibitors or the like.

According to one aspect of the present invention there is provided a method of converting a particulate material to a wetted particulate material and dispensing the wetted particulate material to a surface; said method including the steps of:
a) supplying particulate material to a crushing assembly to crush said particulate material,
b) mixing the crushed material with a liquid to produce a wetted particulate material,
c) dispensing the wetted particulate material.

According to another aspect of the present invention there is provided a method of converting a particulate material using a “converter apparatus substantially as aforementioned, said method including the processes of:
supplying particulate material to the crushing assembly,
operating the crushing assembly to crush the particulate material,
passing the crushed material to said mixing assembly,
operating said mixing assembly to mix liquid with the crushed particulate material to produce a wetted particulate material.

Preferably the processes of the above-described method are performed continuously and/or simultaneously.

In a further embodiment the method may include the further step of supplying an additive to the mixing assembly to mix with the crushed, material.

In another aspect the invention provides a particulate material spreading apparatus having a mixing chamber, the mixing chamber having a particulate material inlet and a liquid inlet, the apparatus also including agitation means adapted to mix any substantially dry particulate material that enters the chamber with any liquid that is introduced into the chamber, and the apparatus further including delivery means adapted to expel any combined particulate material and liquid from the chamber in such a manner that the combined particulate material and liquid can be spread over a surface in the vicinity of the apparatus.

In a yet further aspect the invention provides a spreader vehicle having one or more particulate material spreading apparatus mounted thereon, the or particulate material spreading apparatus as described in the immediately preceding paragraph.

Preferably the spreader vehicle is adapted to carry particulate material and liquid in a manner that allows the particulate material and the liquid to be supplied to the or each of the particulate material spreading apparatus while the vehicle is moving.

Preferably the apparatus further includes grinding or crushing means adapted to reduce the particle size of the particulate material.

Preferably the grinding or crushing means includes one or more rotatable members adapted to grind or crush particulate material against a cylindrical surface.

Preferably the apparatus further includes air acceleration means adapted to produce airflow to assist in the movement of particulate material through the apparatus.

Preferably the agitation means includes rotating vanes.

Preferably the delivery means includes a rotatable slinging device.

In another aspect the invention provides a method of spreading particulate material from a moving vehicle, the method including the steps of;
mixing the particulate material with a liquid to form a wet powder mixture having a paste-like consistency while the particulate material and the liquid are being carried by the vehicle, keeping the mixture in discrete globules or breaking the mixture into discrete globules, slinging the globules evenly over a surface as the vehicle moves over it.

Preferably the resultant wet powder or paste has a liquid content in the range of five to forty percent by mass.

Preferably the resultant wet powder or paste has a liquid content in the range of seven to twenty percent by mass.

Preferably the method further includes a step of grinding or crushing the particulate material prior to mixing with liquid, to reduce or standardise the particle size while the particulate material is being carried by the vehicle.

Preferably the resulting ground or crushed material has a particle size that is less than 0.5 millimetres across.

In one preferred embodiment the invention provides a truck mounted particulate material ground spreading apparatus which is adapted to mix a substantially dry particulate material with from 7-20% of water w/w immediately before supplying the wetted particles to a spreader disc to spread the wetted particles onto the ground. The apparatus preferably has a plurality of grinding discs above a mixing chamber so that particulate material can be dry ground before mixing with water in the mixing chamber and delivery to the spreader disc. The grinding discs and spreader disc are preferably mounted on a common shaft driven by a hydraulic motor.

### Washing Cycle

In one preferred embodiment, the method of converting a particulate material as described above, further includes the processes of:
stopping the supply of particulate material,
supplying liquid to the mixing assembly to flush from the mixing assembly at least a portion of any remaining crushed material, and
restarting the supply of particulate material.

This flushing operation ensures that there is minimal build-up of particulate material in the mixing assembly which may reduce the mixing effectiveness and/or block the combined liquid product outlet.

### Spreader Method

According to another aspect of the present invention there is provided a method of spreading particulate material substantially as aforementioned, said method including the steps of
a) moving a vehicle carrying particulate material over a surface;
b) crushing the particulate material within an apparatus on or associated with the vehicle;
c) passing the crushed material to a mixing assembly on or associated with the vehicle;
d) operating said mixing assembly to mix liquid with the crushed material to produce a wetted particulate material;
e) dispensing the wetted particulate material to the surface as the vehicle moves over it;

In a further embodiment, step d) of the method substantially as described above may include the further step of treating the crushed material with an additive liquid.

Urea fertilizer can give increased agronomic effectiveness if applied as a paste or slurry of fine particles of urea in water, and more so if a urease inhibitor and/or nitrification inhibitor is included in the fertilizer.

This increased effectiveness results from reduced volatilization of ammonia gas from the urea (due to the urease inhibitor), increased total plant uptake of nitrogen from the urea, increased uptake of nitrogen in the ammonium and urea forms, and an increased proportion of nitrogen absorbed directly through the leaves, particularly in the form of urea and ammonium.

The application of urea fertilizer by the present invention may thus be highly effective, as the crushing assembly may be used to crush the urea granules or ‘prills’ (in one preferred embodiment incorporating an inhibitor) and pass the crushed material to the mixing assembly to mix with water (in one preferred embodiment, a water content of 5-10% of total weight) and apply the wetted particulate material, in what is typically a slurry form, to the crop or pasture. At this water percentage, some of the wetted particulate material will remain on the leaves to be available for direct absorption, while the remainder may fall through the leaf canopy to the soil, to be available for uptake through the roots. Typical application rates for dispensing this fertilizer-type may be in the range 20-200 kg urea/ha.

If it is desired to achieve a higher proportion of foliar uptake, in one preferred embodiment, the proportion of water mixed in via the mixing assembly may be varied by the control system to provide a water content of 50-70% of total weight. Preferably, the rate of application of this fertilizer is 10-50 kg of urea per hectare.

Fertiliser products such as lime and direct-application soft phosphate rock (called reactive phosphate rock or RPR in New Zealand and Australia), typically need to be applied in a finely ground form to be agronomically effective. Lime is usually crushed into fine particles in the quarry where it is mined, while RPR is usually crushed prior to beneficiation to improve the grade, at or near the mining site. These ground products can be extremely dusty, creating dust drift and associated problems. Furthermore, both types may require additional grinding/crushing prior to application to be adequately effective agronomically. The present invention may thus be capable of being configured to crush particulate material to the required size, as well as wetting the fertilizer by mixing with water to produce a wetted particulate material with a water content of 5-10% of total weight to minimise dust during application. Application rates of this wetted product (on a dry-material basis) would typically be in the range of 100-300 kg RPR/ha, and 250-1000 kg lime/ha though this should not be seen to be limiting.

Poorly granulated fertilizers, and bulk blends of granulated and fine-particle fertilizers are also prone to problems with both dust and unevenness of application. Thus the present invention may minimise these problems of mixed blends of fertilizers by crushing the solid fertilizer into a narrower range of particle sizes to avoid segregation of the constituent fertilizer-types, and then mix the crushed material with 5-10% of water to produce a well-mixed, dust-free wetted particulate material for spreading. Application rates of this liquid product type would typically be in the range of 200-800 kg fertilizer/ha though this should not be seen to be limiting.

If surface application of granulated fertilizer is followed by rainfall/irrigation-induced run-off, considerable losses of fertilizer nutrients can occur in the run-off, resulting in both economic loss and eutrophication of waterways. This nutrient loss occurs if the fertilizer granules are either physically carried off in the run-off water, or more typically, dissolved into the run-off water before they have, had the opportunity to be washed into the soil, for uptake by plant roots.

The present invention may minimise these losses by partial grinding of the fertilizer and mixing it with 7-20% water, before applying the product, typically as a wet powder, it is almost but not quite a slurry, thereby enabling the fertilizer to dissolve into the soil much more rapidly. Application rates of this liquid product type would typically be in the range of 50-500 kg fertilizer/ha though this should not be seen to be limiting.

Thus preferred embodiments of the present invention may provide significant advantages over prior art, including providing a converter apparatus capable of one or more of:
reducing the size of particulate material;
treating the particulate material and/or adding additives to it
converting the particulate material to a wetted product and dispensing same without clogging;
adjusting the level of liquid content in the wetted particulate material;
spreading solid, dry, wetted and/or liquid material.

Preferred embodiments of the present invention may also provide a converter apparatus capable of reducing one or more of:
dust pollution;
‘run-off’ of fertilizer into waterways;
transport costs,
labour requirements;
the effective applied cost of fertilizer

The invention may also broadly be said to consist in the parts, elements and features referred to or indicated in the specification of the application, individually or collectively, and any or all combinations of any two or more of the parts, elements or features, and where specific integers are mentioned herein which have known equivalents, such equivalents are incorporated herein as if they were individually set forth.

### DESCRIPTION

Further aspects and advantages of the present invention will become apparent from the following description which is given by way of example only and with reference to the accompanying drawings in which:

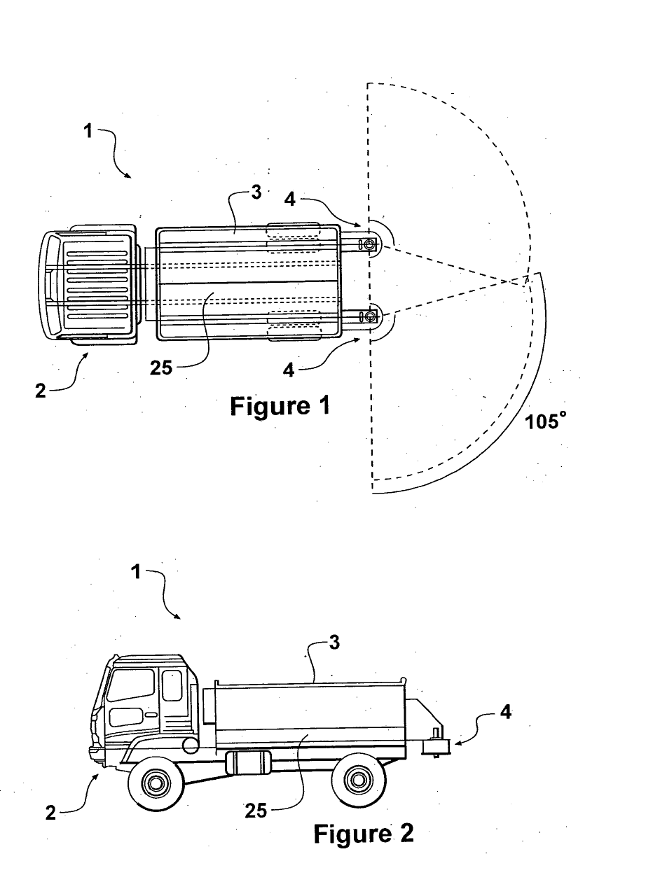

FIG. 1 shows a plan view of a vehicle according to one preferred embodiment of the present invention;

FIG. 2 shows a side view of the vehicle shown in FIG. 1;

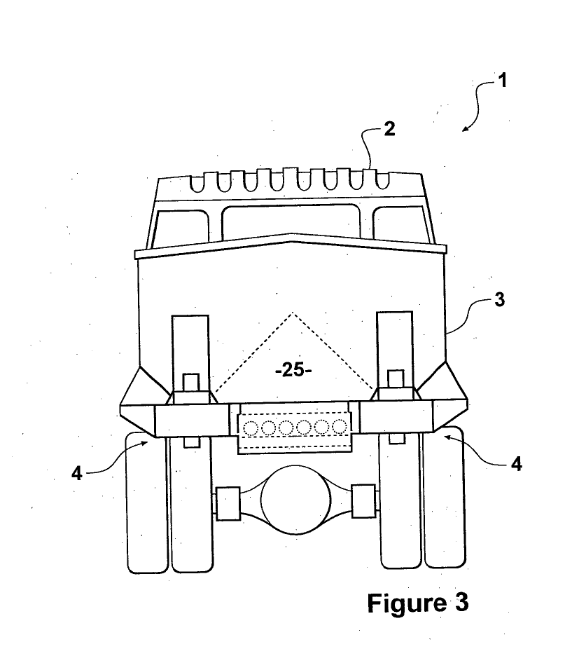

FIG. 3 shows a rear view of the vehicle shown in FIGS. 1 and 2;

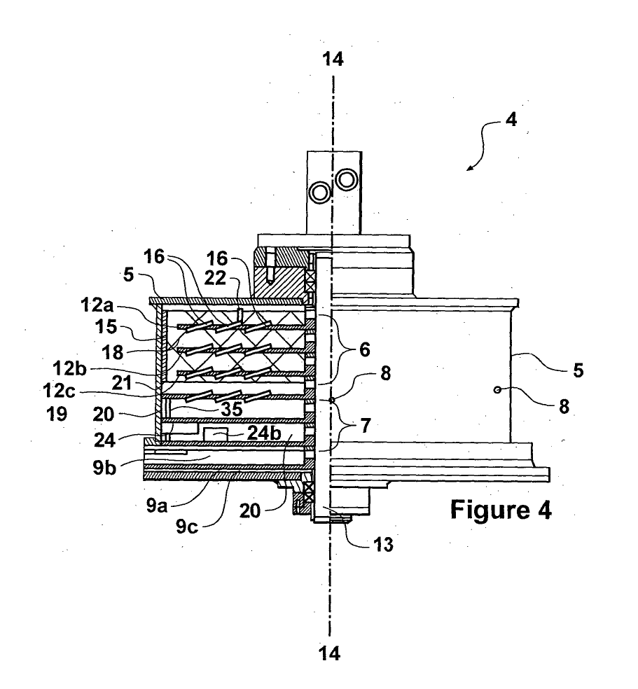

FIG. 4 shows a partial-section side elevation of a spreader apparatus according to a preferred embodiment of the present invention;

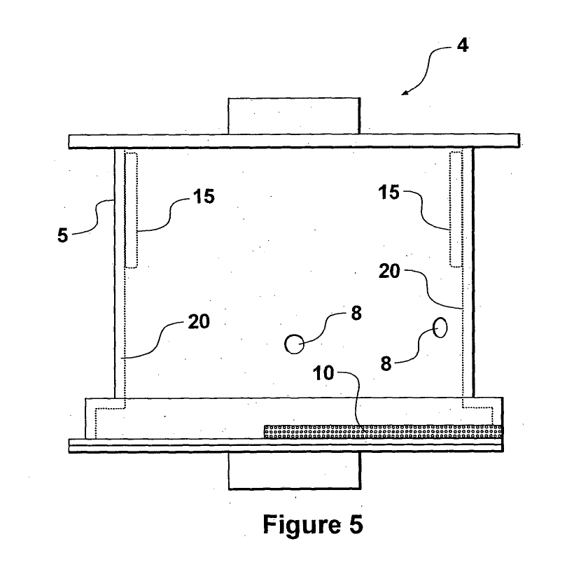

FIG. 5 shows a side elevation of the spreader apparatus shown in FIG. 4;

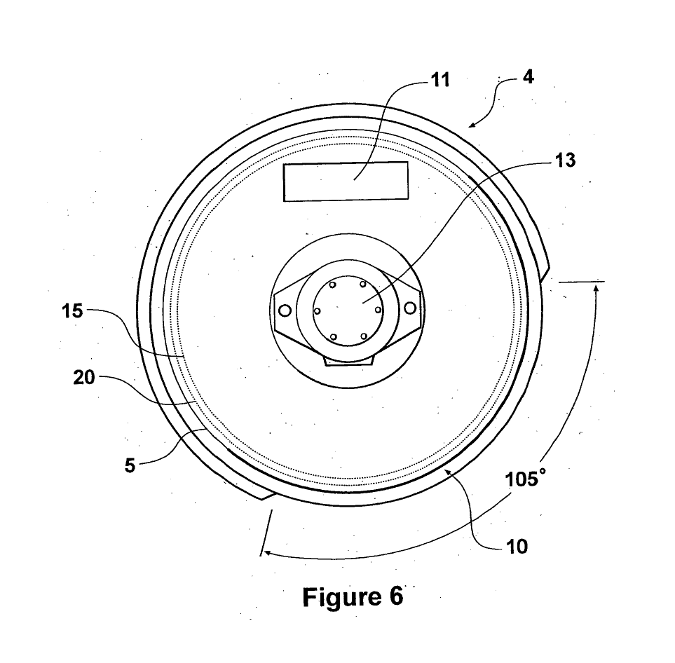

FIG. 6 shows a plan elevation of the spreader apparatus shown in FIG. 4;

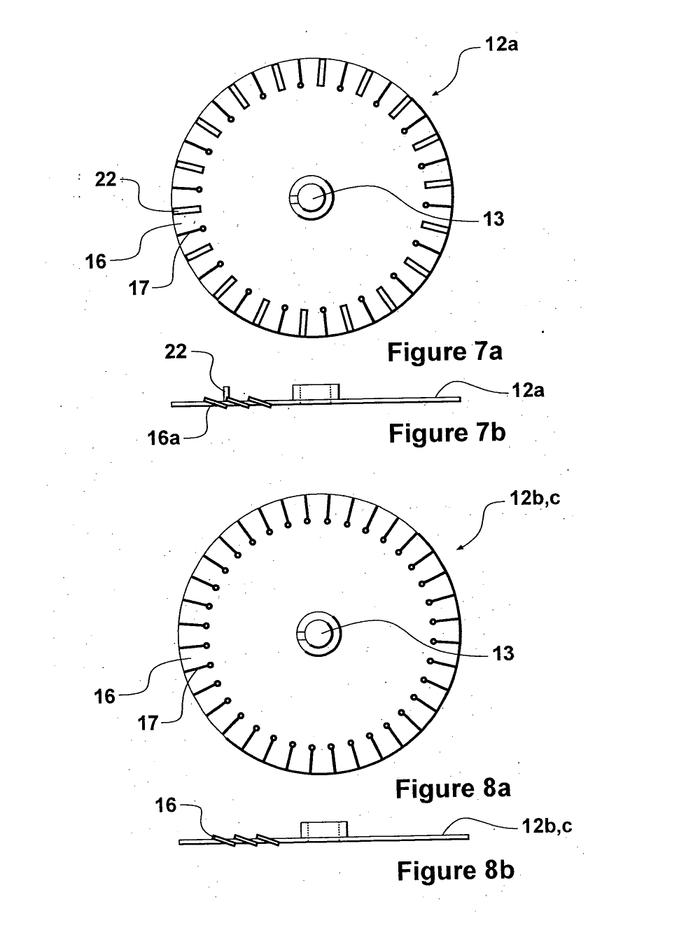

FIGS. 7a-b respectively show a plan view and a partial-section side view of an upper crushing disc according to a preferred embodiment;

FIGS. 8a-b respectively show a plan view and a partial-section side view of a crushing disc according to a preferred embodiment;

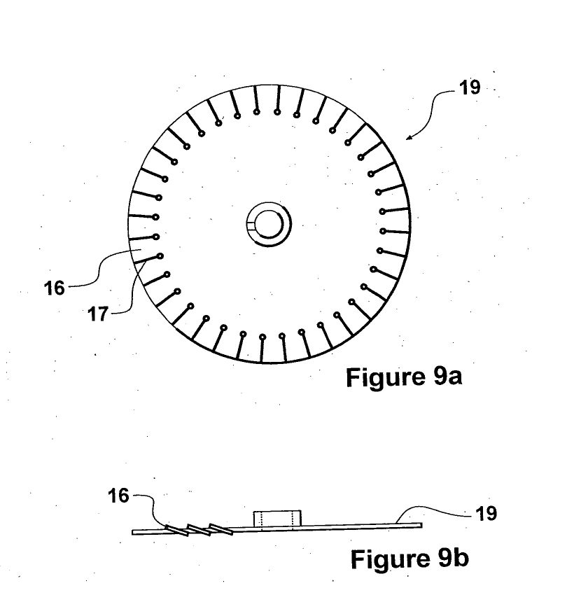

FIGS. 9a-b respectively show a plan view and a partial-section side view of a separation disc according to a preferred embodiment;

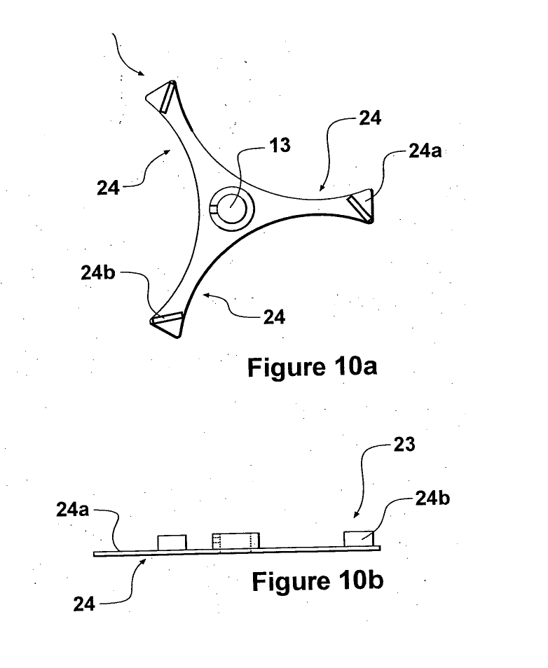

FIGS. 10a-b respectively show a plan view and a partial-section side view of agitation means according to a preferred embodiment;

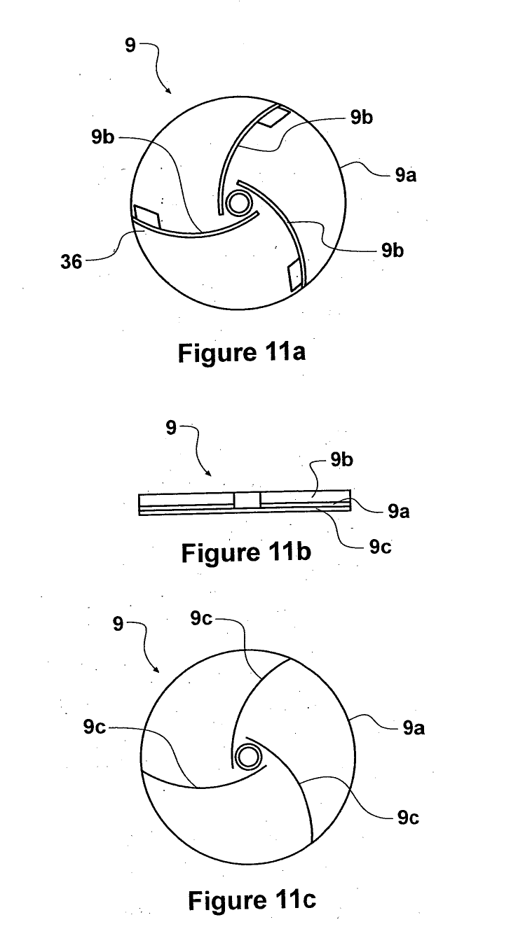

FIGS. 11a-c respectively show top plan view, the side view and the underside plan view of an impeller according to one preferred embodiment;

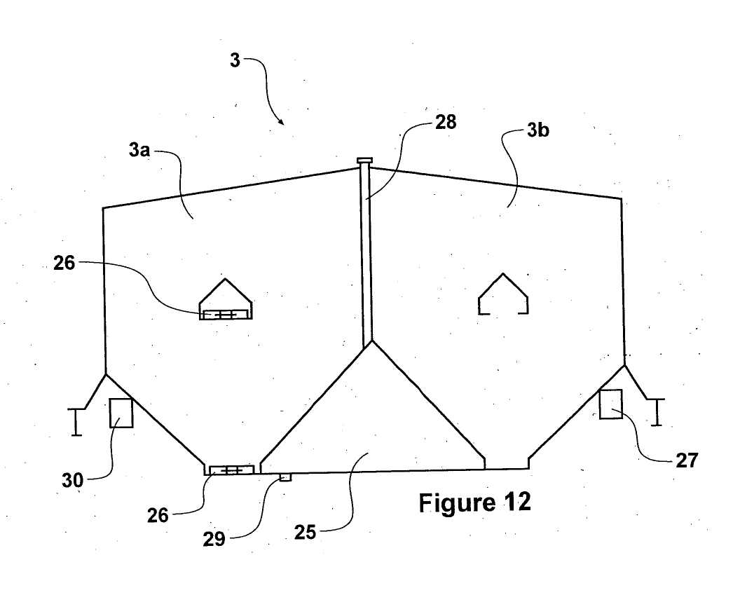

FIG. 12 shows an end elevation view of the rear of a vehicle according to another preferred embodiment;

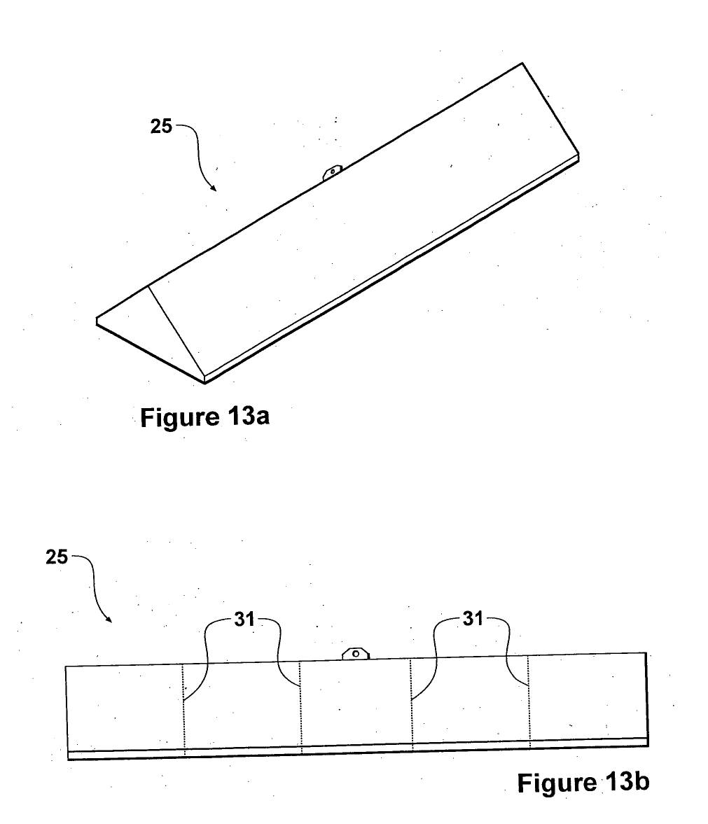

FIGS. 13a-b respectively show perspective and side elevation views of the water tank shown in FIG. 12;

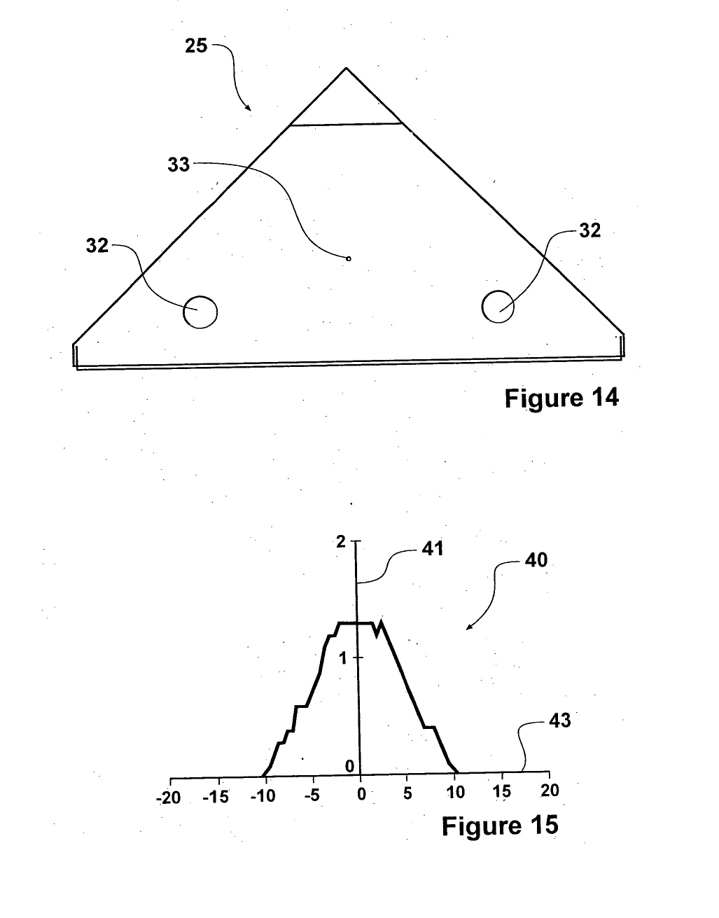

FIG. 14 shows a transverse cross-section of the water tank of FIGS. 12 and 13;

FIG. 15 shows a spreading distribution graph.

FIGS. 1-3 show a vehicle (1) equipped with two particulate material spreading apparatus (4) according to a preferred embodiment of the present invention. One on the right rear of the vehicle and one on the left rear of the vehicle. In this example the vehicle (1) is a truck with an engine and cab unit (2), and a solid particulate material supply in the form of fertilizer container (3). The vehicle (1) also has a liquid supply in the form of a water tank (25) (shown in FIGS. 12-14) for supplying water to two particulate material spreading apparatus (4) attached to the rear of the vehicle (1). The apparatus (4) is designed to operate and spread particulate material as the vehicle (1) moves across a surface, for example across a grassy field.

The right side particulate material spreading apparatus (4) has a spreader disk (rotatable impellor) which is designed to spin clockwise with the crusher disks when viewed from above in FIG. 1, whilst the left hand set (viewed from above) spin counter clockwise.

Each particulate material spreading apparatus (4) or converter apparatus can convert solid particulate fertilizer (not shown) from the container (3) to a wetted particulate material, or a combined particulate material and liquid, which can then be dispensed onto the ground behind the vehicle (1) as it moves along. The particulate material can be in the form of a substantially powdered product, or a product comprising larger particles or pellets. Where the apparatus is used to spread larger particles or pellets, the apparatus can include means to grind the larger particles or pellets into finer particles as will be explained below.

FIG. 1 also shows how a typical desired fertilizer spread angle of approximately 180 degrees can be achieved using two particulate material spreading apparatus (4), each providing a spread angle of approximately 105 degrees. The vehicle (1) can drive over an area to be fertilized and is able to continuously spread a wetted particulate material over the area.

FIGS. 4-11 show a single particulate material spreading apparatus (4). The particulate material spreading apparatus (4) has a mixing chamber or enclosure in the form of a cylindrical housing (5) enclosing a grinding or crushing assembly (6) for grinding or crushing the fertilizer, and an agitation or mixing assembly (7) for mixing the fertilizer from the crushing assembly (6) with water or other liquid from a pair of liquid inlets (8). The liquid inlets (8) are connected to the water tank (25) via a pipe and pump arrangement (not shown).

The apparatus (4) also has a delivery means or a dispensing assembly in the form of rotatable impeller (9) which can spin to expel or eject the wetted fertilizer out of the apparatus (4) through a fertilizer outlet (10). In this example, the fertilizer outlet (10) is in the form of a slot aperture. The slot aperture extends about the lower part of the housing (5) in the form of an arc, and in this example, the arc has a subtended angle of between 70 to 105 degrees. FIG. 5 shows the right hand version with its slot on the right hand side. The left hand apparatus will have its outlet slot on the left (when viewed from the rear of the truck looking forwards as in FIG. 3).

The housing (5) also has a particulate material or fertilizer inlet (11) which is adapted to receive fertilizer from the fertilizer container (3) via a conveyor (26) (shown in FIG. 12). The particulate material inlet (11) is situated in an upper part of the apparatus (4) and the outlet (10) is situated in a lower part of the apparatus (4). This configuration means that gravity can be used to assist the progress of particulate material through the apparatus (4).

The arrangement of each apparatus (4) is such that fertilizer from the conveyor (26) can fall onto an upper crushing disc (12a) (more clearly shown in FIG. 7a, b), of a set of three crushing discs (12a-c) (shown more clearly in FIGS. 8a, b), which together make up the grinding or crushing assembly (6).

The crushing discs (12a-c) are attached to a rotatable axle (13) that can be rotated or spun about a rotational axis (14) such that the fertilizer falling into the crushing assembly (6) is spun out under centrifugal effects onto a hardened or wear resistant surface of a cylindrical crushing wall (15) which is located inside the cylindrical housing (5). The rotatable members or discs (12a-c) of the crushing assembly (6) typically operate at between ten and thirteen thousand revolutions per minute.

While some of the fertilizer may break into smaller particles on impact with the crushing wall (15) the majority of fertilizer is crushed on the crushing wall (15) and/or between the wall (15) and a number of radially extending fins or blades (16) which are situated about the periphery of each of the crushing discs (12a-c). The blades (16) are angled with respect to the plane of the discs (12a-c) to form an air acceleration means in the form of an axial flow compressor disc. The outer periphery of each blade (16) pass adjacent to the inner cylindrical surface of the crushing wall (15) and can create a crushing or grinding action as they interact with the crushing wall (15). The body of each blade (16) can also act as a fan blade to induce a flow of air through the apparatus (4).

The particulate material will generally pass between the periphery of each of the grinding discs (12a-c) as it passes through the apparatus (4), while air and perhaps some lighter dust particles can travel between the blades (16).

The upper crushing disc (12a) has flanges (22) extending perpendicular to the disc on every second blade (16). These flanges can help to distribute particulate material about the full circumference of the discs (12a-c) even though the material enters through a single particulate material inlet (11).

As noted above, not all particulate materials need to be crushed or ground prior to spreading using the apparatus (4) described herein. Tests have shown that the apparatus (4), without a crushing assembly (6), can be used successfully to spread lime, including ‘fine lime’ or ‘lime flour’, which is supplied as a relatively fine powder. The lime can be so fine in fact that it is very susceptible to being carried away by light winds and can therefore be a nuisance or a hazard to surrounding properties when it is applied to a field. Tests showed that the wetted lime can be spread successfully using the apparatus (4) and with little or no losses due to wind drift.

When it is necessary to grind or crush the particulate material, the crushing assembly (6) is ideally configured to reduce the size of the fertilizer or other particulate material to particles that are typically less than 1.5 millimetres across.

A size distribution analysis has been carried out on a sample of urea that was ground or crushed in an early prototype of the crushing assembly (6). The urea was in the form of pellets having a size of between three to six millimetres prior to being crushed. The crushed sample was dried in a 60° C. oven prior to the size distribution analysis. Any clumps were dispersed either by hand or by light grinding, and the sample was then brushed through a series of measuring sieves. The results are provided in the following table;

| | PERCENTAGE OF |
|---|---|
| | UREA SAMPLE BY |
| SIZE RANGE (mm) | WEIGHT |
| 1-2 | 3.3 |
| 0.5-1 | 20.0 |
| 0.25-0.5 | 23.0 |
| 0.15-0.25 | 18.1 |
| 0.075-0.15 | 28.6 |
| 0.045-0.075 | 7.0 |
| <0.045 | 0 |

The above results are for one version of the crushing assembly (6), and with one type of fertilizer. It is envisaged that the actual particle sizes and particle size spread will vary to some extent for different crushing assemblies and different fertilizers. However, it is considered advantageous to be able to grind the particles to an extent that the majority of the particles are less than about 1.5 millimetres across, and/or sixty percent of the particles are less than about 0.5 millimetres across, and/or thirty percent of the particles are less than about 0.15 millimetres across.

Raised ridges (18) can be provided on the inner surface of the cylindrical steel housing (5) or on the crushing wall (15) to assist with the grinding or crushing process, for example by depositing a hard wearing material using an arc welding process.

After being crushed by the crushing assembly (6) the particulate material is blown and/or falls toward a separation disc (19) (shown in FIGS. 9a and 9b) that separates the mixing assembly (7) from the crushing assembly (6). The particulate material can pass about the outside diameter of the separation disc (19) along with the airflow through the spreading apparatus (4). The separation disc (19) is designed to inhibit the passage of, liquid from the mixing assembly (7) toward the crushing assembly (6). Liquid may tend to clog or otherwise reduce the efficiency of the crushing assembly (6).

In this example, the crushing wall (15) has a slightly smaller diameter than the adjacent mixing wall (20) which is simply the internal diameter of the cylindrical housing (5). The change in diameter provides a step (21) between the crushing wall (15) and the mixing wall (20). The separation plate (19) is generally similar in shape to, but has a larger diameter than, the crushing plates (12b, c). The separation plate (19) is also of a slightly smaller diameter than the mixing wall (20). Thus, the separation plate (19) can spin freely but, in combination with the step (21), can inhibit water passing up into the crushing discs (12a-c) of the crushing assembly (6).

The mixing assembly (7) includes agitation means in the form of two agitators (23), each having three mixing blades (24) (shown more clearly in FIGS. 10a and 10b). In this example the mixing blades (24) of each agitator are coplanar and can be manufactured by cutting them from a single sheet of material. Each blade (24) has a planar blade portion (24a). The mixing blades (24) are connected to the axle (13) and can, rotate at high speed along with the crushing discs (12a-c). The agitators (23) mix the crushed fertilizer falling from the crushing assembly (6) with water from the liquid inlets (8).

The inlets (8) can be simple holes of approximately 2-4 millimetres diameter, and the water, or other liquid, can be supplied into the mixing assembly (7) in one or more solid jets, or be broken up into droplets using suitable spray nozzles. The drawings show two inlets (8). Both situated to direct water into an upper part of the mixing assembly (7). However, trials have shown that having one or more inlets (8) in the upper part of the mixing assembly (7), and one or more inlets (8) in a lower part of the mixing assembly (7) can help to reduce the occurrence of clogging within the mixing assembly (7).

The agitators (23) can also include vanes (24b) which extend perpendicular to the blades (24). The vanes (24b) can extend either side of the blades (24) and are designed to increase the shearing or mixing action within the mixing assembly (7) and/or to induce an airflow which tends to deliver any mixed or combined particulate material and liquid toward the centre of the rotatable slinging device or impellor (9). At this location in the spreading apparatus (4) the combined particulate material and liquid is in a wet powder or paste like form which is generally broken up into small or discrete droplets or globules.

The rotatable impeller (9) is shown more clearly in FIG. 11 and includes a planar disc (9a) with three curved flanges (9b) which extend perpendicular to the disc (9a). The flanges (9b) are configured to take the combined particulate material and liquid that is received from the agitators (23) and to eject it out through the outlet (10) at high velocity.

We have found that these covered flanges are much more effective in distributing the wet powder than the much shorter straight radial flanges used on the periphery of conventional spinner disks used with dry powders. Conventional ground spreads have one large uncovered spinning disk at the centre rear of the vehicle, and tend to waste material.

The impeller (9) also has three flanges (9c) underneath to disperse any excess water or paste that may interfere with the rotation of the impeller (9). Cleaning blades (35) which are generally aligned parallel to the rotational axis (14) can be connected between the impeller (9) and agitators (23) to help to keep the mixing wall relatively clear also. The flanges (9b) of the impellor (9) can also be provided with guide vanes (36) that are generally aligned parallel to the impellor disc (9a), to help to guide the combined particulate material and liquid out through the outlet (10), to minimise the build up of material about the edges of the outlet (10). The rotatable slinging device or impellor (9) can in a preferred embodiment have a diameter slightly larger than the outer diameter of the agitators (23), to ensure that all the ground material is collected from the mixing assembly (7) and falls onto the impellor (9) to ensure that it is evenly dispensed over the surface or field. In the case of urea, testing has shown that an even spread is attainable to a width of thirteen and a half metres using the vehicle (1) described herein. We have found that the impeller and crushing disks work efficiently between 800 and 2000 rpm. We prefer to operate the impeller at a constant speed of 1300 rmp to control the uniformity of spread. Our tests were carried out on a prototype impeller 600 mm in diameter rotating at 1300 rmp whilst the vehicle traveled at 20 kmh.

FIG. 15 shows the results of measured urea distribution analysis using the vehicle (1) described herein. The horizontal axis (43) shows meters from the centerline of the track of the vehicle (1). And the vertical axis (41) shows the grams of urea collected in 500 millimeter (mm) by 500 mm trays that were placed at set distances from the centerline of the track of the vehicle (1). The results of the analysis showed that the vehicle (1) can spread urea, with a coefficient of variation of application rate, of less than fifteen percent, when the vehicle (1) passes along parallel paths that are less than or up to thirteen and a half metres apart. The figure of thirteen and a half metres is known in the industry as a “Bout width”. The spread achieved on a single path shown in FIG. 15, will result in more even distribution as adjacent spread paths overlap if they are within say 13.5 m or less apart.

The crushing discs (12); separation plate (19), mixing blade-sets (23) and rotatable impeller (9) are all connected to the central axle (13) and configured to rotate in unison about the rotational axis (14) in a clockwise direction with respect to a plan elevation of the right rear particulate material spreading apparatus (4). The left rear set will be a mirror image of the right set and is designed to rotate in a counter clockwise direction.

FIG. 12 shows the container (3) in more detail which has two storage portions (3a, b) located above the water tank (25). The storage portions each have a conveyor (26) (but only one such conveyor is illustrated) for transferring fertilizer from the container (3) to the fertilizer inlet (11) of the particulate material spreading apparatus (4). A hydraulic valve block (27) and associated hydraulic motors and lines (not shown) are provided for driving the conveyors and particulate material spreading apparatus (4).

The water tank (25) is substantially triangular in Cross-section and is aligned with the centerline of the truck (1) to minimise the effects of movement of water within the tank when the truck is moving. The water tank (25) also has a filling and breathing pipe (28) to allow the tank to be filled and to permit entry of air when the tank is being drained. Four outlets (29) (only one shown) are provided on the bottom of the tank (25) and are connected to respective water pumps (30) (only one shown) via pipes (not shown). The water pumps (30) each supply water and/or other liquids to the liquid inlets (8) of the particulate material spreading apparatus (4) via pipes (not shown). FIG. 13b shows a series of baffles (31) for preventing water surges in the tank (25). As shown in FIG. 14, each baffle (31) has transfer apertures (32) for the passage of water between compartments and are collectively connected together via a steel rod (33) which helps to increase the rigidity and prevent any deformation of the baffles (31).

The invention provides a method of spreading particulate material from a moving vehicle, the method including the steps of;
mixing the particulate material with a liquid to form a mixture having a paste-like consistency while the particulate material and the liquid are being carried by the vehicle,
keeping the mixture in discrete globules or breaking the mixture into discrete globules,
slinging the globules evenly over a surface as the vehicle moves over it.

The method can further include a step of grinding or crushing the particulate material to reduce or standardise the particle size while the particulate material is being carried by the vehicle.

The method is primarily designed for the purpose of spreading particulate material in the form of fertilizer, and typically the liquid that is mixed with the fertilizer will be mainly water. However in some applications additional chemicals or compounds may be added to the water, for example a compound adapted to condition the fertilizer in some way, an example being a nitrification and/or a urease inhibitor.

The wetted fertilizer that is deposited by the method and apparatus described herein can adhere to the leaves or blades of pasture, which can help to increase the rate at which the fertilizer is absorbed directly by the leaves or blades, that is the filial absorption. This is particularly true in the case of urea fertilizer.

The vehicle (1) also includes a control system (not shown) that includes a microprocessor, associated hardware and software. The control system is manually operable and is also linked to sensors (not shown) for measuring the vehicle speed, rate of rotation of the particulate material spreading apparatus (4) and the volume flow-rate of fertilizer and water to the particulate material spreading apparatus (4).

The control system (not shown) which has a suitably programmed microprocessor (not shown) can adjust the respective flow-rates of the fertilizer and water to the crushing (6) and mixing (7) assemblies and therefore control the ratio of water to fertilizer of the final product.

Preferably the vehicle (1) is provided with an electronic guidance system which is configured to guide the vehicle along a number of parallel paths that are a set distance apart, for example an electronic guidance system that uses a Global. Positioning System. The spacing of the parallel paths would ideally correspond to a certified bout width of the vehicle (1).

In the preferred mode of operation the fertilizer is only required to be wetted, the process of which may induce some dissolution of the fertilizer. The water pump and fertilizer conveyor can be controlled via the microprocessor to supply water at a rate that will enable the apparatus (4) to produce a wetted particulate material or paste having a water content in the range of five to thirty percent by mass, or preferably within the range of five to twenty percent. Testing has shown that for granulated urea fertilizers, a water content in the range of eight to twelve percent by mass (w/w) is preferable, and for fine fertilizers such as ‘fine lime’ a water content in the range of fifteen to eighteen percent by mass (w/w) is preferable. If the water content exceeds these ranges, the wetted fertilizer can become too liquid, and the water usage can become excessive, requiring the vehicle to be refilled at an inconvenient rate. If the water content is less than these ranges, the wetted fertilizer can form into larger lumps and/or clog the impellor (9). Noting that some fertilizers, e.g. *** based fertilizers are hydroscopic, we believe that the total water content should be measured on a w/w base of the final product.

The control system can also control via the microprocessor the distance and amount of wetted product to be spread by controlling the speed of rotation of the impeller (9).

The microprocessor is programmed to control the wetted particulate material ratios and impeller (9) rotation rate within predetermined limits to ensure the desired fertilizer application is achieved. The microprocessor is also capable of determining vehicle speed and other variables from the sensor signals and set the water and fertilizer levels in the wetted particulate material and impeller (9) rotation rate accordingly to maintain the desired application rate.

The microprocessor also includes a programmed wash-cycle that can be activated via the control system which will then continue to supply water to the particulate material spreading apparatus (4) but stop supply of the fertilizer for a short period of time or predetermined number of revolutions. This wash-cycle flushes the mixing assembly (7) and impeller (9) with water and thus ensures that there is minimal build-up of fertilizer which would otherwise reduce the converting effectiveness and/or block the fertilizer Outlet (10).

The microprocessor may also be set to shut-off the water supply to the converter units (4) and therefore allow crushed product to be distributed without any water content.

### Calculations

These calculations are by way of example and are not intended to be limiting in any way. They help to understand the operation of the invention.

Assume that a ground spreader truck of this invention can carry 3 tons of dry fertilizer and 1.5 tons of water.

The following calculations show what can be achieved with a “bout width” of 12 metres.

Assume the water percentage is set at 10% for urea.

For a truck to cover 200 ha per day at an application rate of 60 kg/ha=200×60=12000 kg=12 tons of wet urea (of which 1.2 tons would be water).

At the slowest average speed of 10 kph (this allows easy calculations at 20 kph, 30 kph etc).

In an 8 hour driving day the coverage is 8×10,000 m/h by 12 metres wide=960,000 sq m in 1 day.

10,000 sq m=1 ha, thus the truck can cover 96 ha per day at 10 kph.

But 96 ha requires only 96 ha×60 kg/ha=5760 kg or 5.76 tons.

This is made up of 0.576 tons of water and 5.184 tons of dry urea.

Or the truck can cover 192 ha/day at 20 kph (which is the speed used in our tests).

192 ha×60 kg/ha=11,520 kg (11.52 tons) of finished product delivered to the pasture.

At this speed only 1.152 tons of water is used per day.

In practice we can deliver a uniform application of wet powder at an average speed of up to 30 kph over rolling pasture, which in 8 hours of driving time allows coverage of up to 288 ha in area at 30 kph. This requires 17,280 kg or 17.28 tons of finished product. At this speed only 1.728 tons of water is used per day.

Note these calculations ignore any refilling or refueling or other downtime. In most cases the central water tank will be large enough to accommodate a day's spreading without refilling the water tank (although the fertilizer hoppers will need to be refilled during the course of the day).

### Variations

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

In the example described above the spreading apparatus (4) is described having liquid or water inlets (8). While the inlets (8) can take the form of a simple orifice, they can also be in the form of an injection nozzle. The injection nozzle or nozzles can be controllable, for example electronically controllable allowing the size of an opening in each nozzle to be varied, and/or allowing the nozzle to be pulsed open and closed, as required to control the flow rate of a liquid through each nozzle.

In the example above the spreading apparatus (4) is shown fitted to a vehicle in the form of a truck. In alternative applications the spreading apparatus (4) could be used in conjunction with other vehicles, for example a tractor, or a helicopter or a fixed wing aircraft. One or more apparatus (4) can be used with each vehicle.

The apparatus (4) described herein is primarily designed to mix and spread evenly a wetted particulate material having less than thirty percent water by weight. However in other applications, it may be desirable to spread or apply a particulate material in a suspension, rather than as a paste, for example when applying a pesticide application. In such a case the water feed rate could be increased to provide a water content percentage of 30-50 percent of total weight.

And in further applications where a particulate material is required to be substantially dissolved in water, the water feed rate could be increased to provide a water content percentage of 50-90 percent of total weight.

### DEFINITIONS

Throughout this specification the word “comprise” and variations of that word, such as “comprises” and “comprising”, are not intended to exclude other additives, components, integers or steps.

### Advantages

Thus it can be seen that at least the preferred form of the invention provides a spreading apparatus or method which can help in one or more of the following areas;
reduce wind blown losses of fertilizer or pollution caused by fertilizer,
allow accurate spreading of a wetted fertilizer
improve folial uptake of a fertilizer,
allow nitrification and/or urease inhibitors to be added to fertilizers, or
reduce fertilizer run-off or leaching into waterways.
It can accommodate non-uniform agricultural material (fertilizer or lime) that has been poorly ground or badly graded, or one that has clumped excessively during storage, as the material can be ground to size in the vehicle immediately before application.
Water tank is centrally located to minimise vehicle instability on hilly country.
Water, usage is minimal (less than 20% w/w of product applied) so that sufficient water can be carried for at least a full day's work without the need to refill the water tank.

1-12. (canceled)

13. A particulate material spreading apparatus having a mixing chamber, the mixing chamber having a particulate material inlet and a liquid inlet, the apparatus also including agitation means adapted to mix any substantially dry particulate material that enters the chamber with any liquid that is introduced into the chamber, and the apparatus further including delivery means adapted to expel any combined particulate material and liquid from the chamber in such a manner that the combined particulate material and liquid can be spread over a surface in the vicinity of the apparatus.

14. A spreader vehicle having one or more particulate material spreading apparatus mounted thereon, the or particulate material spreading apparatus being as claimed in claim 13, and wherein the vehicle is adapted to carry particulate material and liquid in a manner that allows the particulate material and the liquid to be supplied to the or each of the particulate material spreading apparatus while the vehicle is moving.

15. A spreader vehicle as claimed in claim 14, wherein the or each apparatus further includes grinding or crushing means adapted to reduce the particle size of the particulate material.

16. A spreader vehicle as claimed in claim 15, wherein the grinding or crushing means includes one or more rotatable members adapted to grind or crush particulate material against a cylindrical surface.

17. A spreader vehicle as claimed in claim 14, wherein the or each apparatus further includes air acceleration means adapted to produce airflow to assist in the movement of particulate material through the apparatus.

18. A spreader vehicle as claimed in claim 17, wherein the agitation means includes rotating vanes.

19. A spreader vehicle as claimed in claim 18, wherein the delivery means includes a rotatable slinging device.

20. A method of spreading particulate material from a moving vehicle, the method including the steps of;
mixing the particulate material with a liquid to form a wet powder mixture having a paste-like consistency while the particulate material and the liquid are being carried by the vehicle,
keeping the mixture in discrete globules or breaking the mixture into discrete globules,
slinging the globules evenly over a surface as the vehicle moves over it.

21. A method of spreading particulate material as claimed in claim 20, wherein the resultant wet powder or paste has a liquid content in the range of five to forty percent by mass.

22. A method of spreading particulate material as claimed in claim 21, wherein the resultant wet powder or paste has a liquid content in the range of seven to twenty percent by mass.

23. A method of spreading particulate material as claimed in claim 22, wherein the method further includes a step of grinding or crushing the particulate material prior to mixing with liquid, to reduce or standardize the particle size while the particulate material is being carried by the vehicle.

24. A method of spreading particulate material as claimed in claim 23, wherein the resulting ground or crushed material has a particle size that is less than 0.5 millimeters across.

25. A spreader vehicle as claimed in claim 15, wherein the or each apparatus further includes air acceleration means adapted to produce airflow to assist in the movement of particulate material through the apparatus.
